(19) United States
(12) Patent Application Publication
(10) Pub. No.: US 2025/0111044 A1
(43) Pub. Date: Apr. 3, 2025

(54) Accelerated Vulnerability Detection and Automated Mitigation

(71) Applicant: Dell Products L.P., Round Rock, TX (US)

(72) Inventors: Alan H. ABDELHALIM, Pflugerville, TX (US); Ibrahim SAYYED, Georgetown, TX (US); Anand Prakash JOSHI, Round Rock, TX (US); Charles D. ROBISON, Buford, GA (US)

(73) Assignee: Dell Products L.P., Round Rock, TX (US)

(21) Appl. No.: 18/480,407

(22) Filed: Oct. 3, 2023

(51) Int. Cl. G06F 21/55; G06F 21/57

(52) U.S. Cl. CPC G06F 21/554; G06F 21/577

(57) ABSTRACT

Disclosed methods and systems consume vulnerability information from one or more security services associated with an information handling system. Based at least in part on the vulnerability information, a vulnerability status of the information handling system and/or an application running on the information handling system is determined. A vulnerability mitigation policy corresponding to the vulnerability status is determined and the vulnerability mitigation policy is then enforced while the vulnerability status persists. Enforcing the vulnerability mitigation policy may include restricting functionality of the information handling system, restricting execution of the application, or both.

### TECHNICAL FIELD

The present disclosure pertains to information handling system security and, more particularly, monitoring and managing vulnerability information of the information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may have or exhibit hardware and/or software vulnerabilities that negatively impact system security. A skilled attacker can exploit a vulnerability to take control of system operation or gain access to confidential and sensitive data, typically for purposes of extorting or otherwise damaging the rightful user or owner of the system. Recent and dramatic increases in targeted discovery of software and hardware vulnerabilities have sparked an evolution of security and patch management products to monitor systems for vulnerabilities and install patches as soon as they become available. However, such solutions tend to focus on vulnerabilities that have new/known patches and Common Vulnerabilities and Exposures (CVEs) at the operating system (OS) or client application level. In addition, conventional solutions often require user action to permit or initiate installation of necessary updates. The disruptive connotations often associated with system updates may result in a tendency for users to defer or postpone update installations until, for example, an administrative deadline is imposed by an information technology (IT) administrator or an OS update agent. This dynamic may result in systems that are unnecessarily susceptible to one or more vulnerabilities until users initiate installation of applicable patches.

### SUMMARY

Problems associated with ensuring timely security updates are addressed by systems and methods disclosed herein, wherein a system inventory, obtained or generated via existing technology and services, is combined with latest available vulnerability data, including hardware and Open Source Software (OSS)/shared library level vulnerability data, to identify vulnerabilities, e.g., OSS library vulnerabilities, before such vulnerabilities are known or patched by the OS or application vendor. In addition, once vulnerabilities are identified, various features of disclosed systems and methods protect the system from exploitation. For example, end users may be encouraged to install patches sooner rather than later by restricting device functionality, such as data wipe functionality, deemed to be sensitive per rules/policies set by IT administrators. In this manner, security is enhanced by preventing continued use of a vulnerable application, whether or not the vendor is aware of the vulnerability or has developed and distributed a patch or update.

Disclosed subject matter enables automated and centralized response for detected vulnerabilities across the entire software stack using defined risk mitigation policies and enforcement mechanisms to force auto-updates, disable sensitive operations, e.g., data wipes and device diagnostics, and the like. Embodiments may include or support automated use of vulnerability data including, as examples, CVE data and software composition data, e.g., Black Duck to automatically identify vulnerable applications (through their use of vulnerable libraries) without waiting for all the impacted application vendors to publish their own advisories and patches.

Embodiments may integrate a vulnerability module into client applications that would automatically recognize when its host application is vulnerable and then accept a corresponding policy from an enforcement agent that would direct it to reduce or disable application functionality as appropriate. It would also guide the user to update the application as soon as an update is available to restore full functionality. This prevents the application from being an attack vector and shortens the timeframe to update.

In at least one aspect, disclosed systems and methods consume vulnerability information from one or more security services associated with an information handling system. The security services may include one or more existing security services provided by the original equipment manufacturer (OEM), the OS vendor, the silicon vendor, or a third party, that are leveraged to assess an overall vulnerability status of the system and/or application software associated with the information handling system. The vulnerability information may include any information indicating a vulnerability of firmware for: one or more hardware components of the information handling system, firmware associated with an OS of the information handling system, system BIOS, and/or a hardware configuration of the information handling system.

Based on an analysis of the vulnerability information, a vulnerability status of the information handling system or an application running on the information handling system is determined and a vulnerability mitigation policy corresponding to the vulnerability status is identified and selected. Determining the vulnerability status may include enumerating devices and device firmware of the information handling system, identifying dependencies associated with the device firmware, and identifying vulnerabilities associated with the device firmware or the dependencies.

In at least some embodiments, determining the vulnerability status may include determining a vulnerability score. In such embodiments, the vulnerability score may provide a metric quantifying information handling system vulnerabilities.

The selected vulnerability mitigation policy is then enforced while the vulnerability status persists, i.e., until vulnerabilities associated with vulnerability status are resolved. In at least some embodiments, enforcing the vulnerability mitigation policy includes automatically restricting functionality of the information handling system or the application. In some embodiments, enforcing the vulnerability mitigation policy includes prohibiting data wipe and other potentially destructive operations. Some embodiments may prevent one or more device diagnostic programs, modules, or services from executing.

In some embodiments, enforcing the vulnerability mitigation policy includes restricting execution of a vulnerable application program. Restricting execution of a vulnerable application program may include prompting a user of the information handling system to update software or firmware associated with the vulnerable application program. In some embodiments, restricting execution of a vulnerable application program includes preventing the vulnerable application program from executing until the update is performed.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an information handling system featuring disclosed vulnerability management features;

FIG. 2 illustrates a vulnerability management method emphasizing vulnerabilities associated with the information handling system;

FIG. 3 illustrates a vulnerability management method emphasizing vulnerabilities associated with an application running on the information handling system;

FIG. 4 illustrates a vulnerability management method encompassing the methods of FIG. 2 and FIG. 3; and

FIG. 5 illustrates an information handling system suitable for use as or in conjunction with features illustrated in FIGS. 1-4.

### DETAILED DESCRIPTION

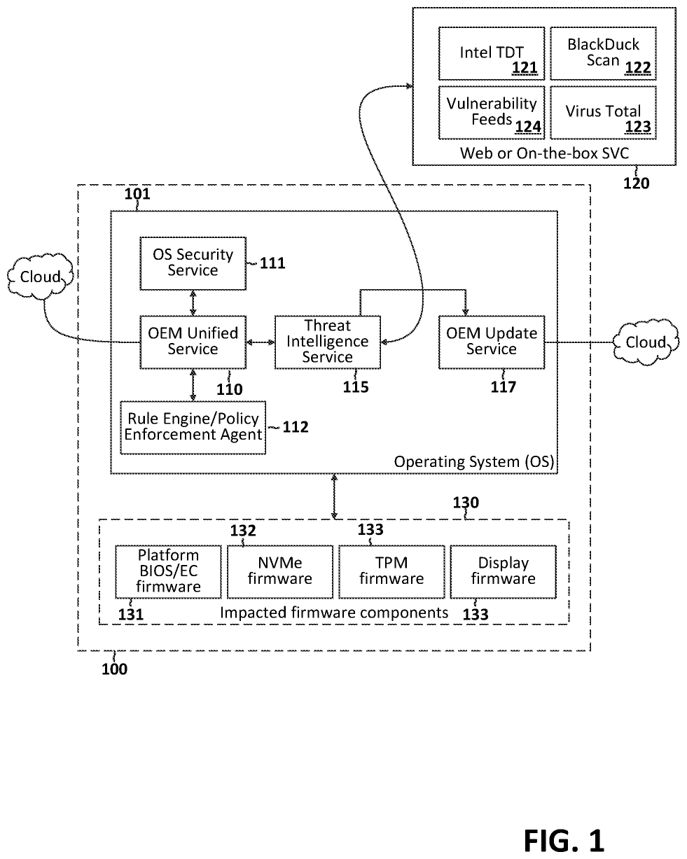

Exemplary embodiments and their advantages are best understood by reference to FIGS. 1-5, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

Referring now to the drawings, FIG. 1 illustrates an exemplary information handling system 100, referred to herein simply as platform 100, featuring an operating system 101 and various firmware components 130 that may be impacted by one or more vulnerabilities. The potentially impacted firmware components depicted in FIG. 1 include platform BIOS and/or embedded controller (EC) firmware 131, nonvolatile memory express (NVMe) firmware 132, trusted platform module (TPM) firmware 133, and display device firmware 134. It will be appreciated that illustrated firmware components 130 are exemplary and that other firmware components not explicitly depicted in FIG. 1 may be impacted by one or more security vulnerabilities of platform 100.

The illustrated OS 101 is provisioned with components suitable to support accelerated detection and automated mitigation of vulnerabilities functionality. Specifically, the operating system 101 depicted in FIG. 1 includes an OEM unified software service 110 communicatively coupled to an OS security service 111, a rule engine and policy enforcement agent 112, a threat intelligence service 115, and an update service 117.

In at least one embodiment, unified software service 110 leverages data from other platform resources including, as examples, trusted device services, telemetry data, and diagnostic services to orchestrate the accelerated detection and automated mitigation of vulnerabilities functionality. The illustrated threat intelligence service 115 may be configured to consume data from multiple sources of vulnerability information and determine whether the platform's devices and applications are impacted.

In at least some embodiments, OEM security service 111 is a preexisting resource configured to ensure users that devices are secured below the OS level. OEM security service 111 may be configured to capture a software/firmware image of the platform as well as platform software and firmware BIOS events and indicators of attack to verify integrity of the platform BIOS using an off-host process that does not interrupt platform boot processes. OEM security service 111 may be configuration to generate a pass/fail result that may be provided to and/or recorded in various resources including, as examples, a web browser, a command line interface, a registry event, and an event viewer. OEM security service 111 may be implemented as or support functionality analogous to functionality of Dell Trusted Device (DTD) Dell Technologies.

Rule engine and policy enforcement agent 112 may, in at least some embodiment, enable IT administrators to define and deploy vulnerability response policies and to configure platform resources to enforce those policies.

The threat intelligence service 115 depicted in FIG. 1 is communicatively coupled to web-based and/or on-the-box third party security resources 120. Third party security services 120 may include various CVE and Common Platform Enumeration (CPE) data feeds and/or APIs configured to perform operations including, as non-limiting examples: scanning applications and container images, identifying open source components, and detecting open source security vulnerabilities, compliance issues, or code-quality risks; analyzing files and URLs for viruses, worms, trojans and other kinds of malicious content; and providing hardware-level cyberattack monitoring to profile malware as it attempts to execute on the CPU microarchitecture. The third party security resources 120 illustrated in FIG. 1 include Intel Threat Detection Technology 121, Black Duck scan 122 from Synopsis, Virus Total 123, and Vulnerability Feeds 124. Those of ordinary skill in the fields of information handling system security will appreciate that the third party resources illustrated in FIG. 1 are exemplary and that other implementations of platform 100 may include more, fewer, and/or different third party security resources.

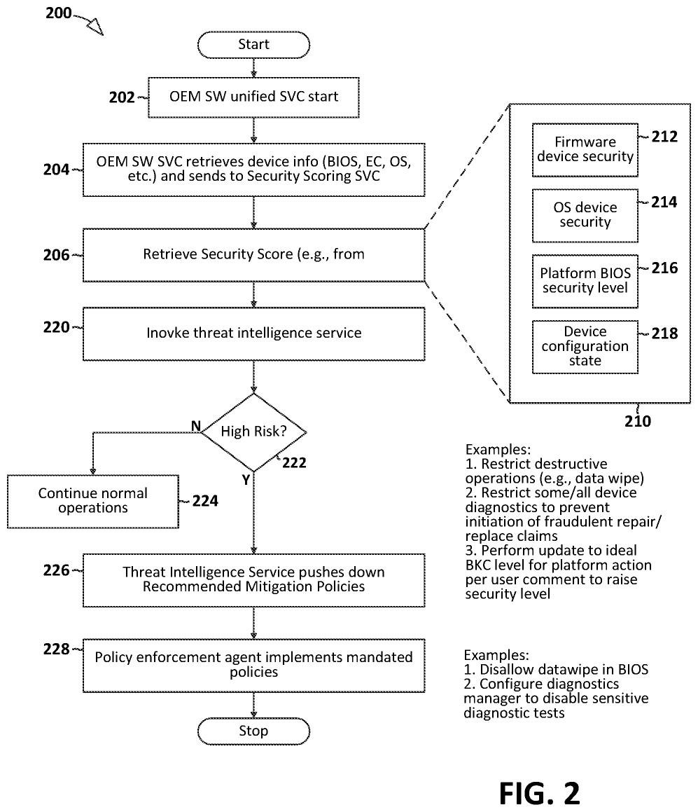

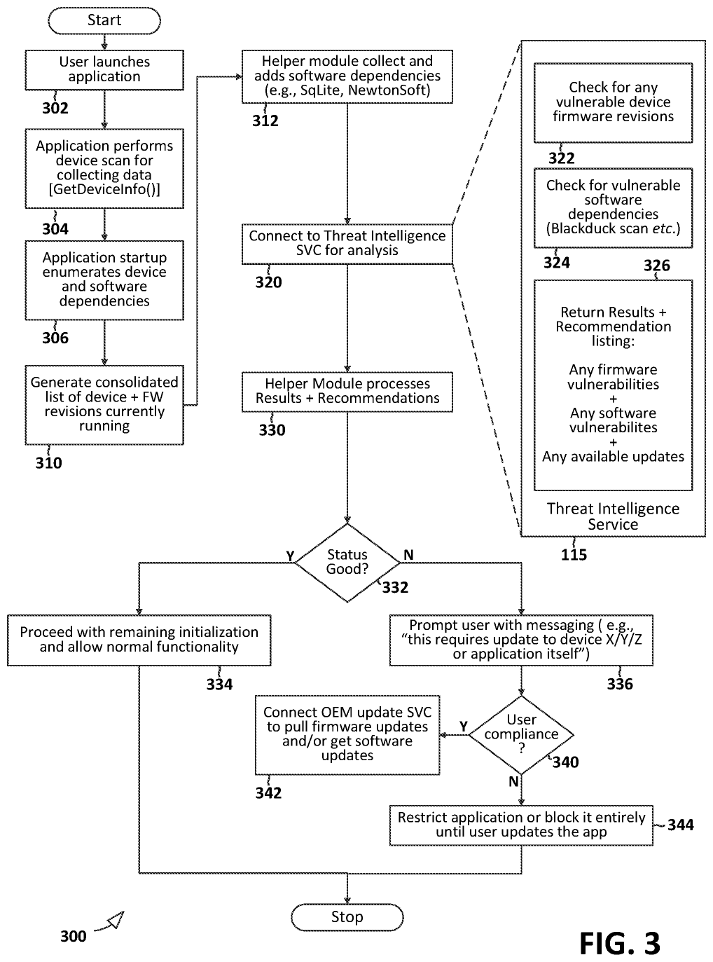

Accelerated detection and automated mitigation of vulnerabilities features disclosed herein may include features emphasizing at least two functional aspects including functionality for restricting system functionality, illustrated in FIG. 2, and functionality for restricting application functionality, illustrated in FIG. 3.

Turning now to FIG. 2, an exemplary accelerated detection and automated mitigation of vulnerabilities process 200 suitable for restricting or otherwise influencing system functionality is depicted. As depicted in FIG. 2, process 200 begins by starting (operation 202) a unified software service, such as the OEM unified software service 110 of FIG. 1. OEM unified software service 110 retrieves (operation 204) device information for various platform devices including, as non-limiting examples, the platform's BIOS, EC, OS, etc., and sends the retrieved information to a security scoring service configured to determine a platform security posture 210 encompassing the platform's firmware device security 212, OS device security 214, platform BIOS security 216, and a device configuration state 218.

The process 200 depicted in FIG. 2 retrieves (operation 206) a security score indicative of the platform security posture 210 and invokes (operation 220) a threat intelligence service such as the threat intelligence service 115 depicted in FIG. 1. The threat intelligence service may determine (operation 222), based on security score and/or other information, whether the platform exhibits a high risk vulnerability. In some embodiments, certain vulnerabilities may be recognized as posing little risk. For example, device firmware or device configuration that may not be fully updated but is not associated with any CVEs may be treated as low risk. If no high risk vulnerability is detected, the platform's normal operations (224) are continued.

If, however, one or more high risk vulnerabilities is detected, the threat intelligence service 115, in conjunction with the rule enforcement/policy agent 112 of FIG. 1, pushes down (operation 226) one or more recommended mitigation policies. The mitigation policies may include, for example, one or more policies to prohibit or restrict execution of data wipe operations and/or other operations classified as destructive or potentially destructive. Another exemplary mitigation policy may prohibit or restrict some or all device diagnostic routines, which may be used maliciously to initiate fraudulent repair/replace claims. Still another exemplary mitigation policy may initiate or update the platform to a best known configuration (BKC) level. It will be appreciated that the exemplary policies explicitly described herein are not exhaustive and that other policies may be appropriate. The process 200 illustrated in FIG. 2 further includes the implementation and enforcement (operation 228) of one or more of the recommended mitigation policies. As an example of policy implementation and enforcement operation 228, the policy enforcement agent may be configured by one or more resources of platform 100 to disallow data wipe operations initiated from a pre-boot or BIOS interface. As another example, policy implementation and enforcement operation 228 may be configured to disable execution of device diagnostic tests. Again, however, it will be appreciated that other exemplary enforcement activities may be suitable in other implementations.

Turning now to FIG. 3, an exemplary accelerated detection and automated mitigation of vulnerabilities process 300 suitable for restricting or otherwise influencing application program functionality is depicted. The illustrated process 300 begins when a platform user launches (operation 302) an application program. The application may perform a device scan (operation 304) to collect device information. Based, at least in part, on the collected device information, the application enumerates (operation 306) device and software dependencies and generates (operation 310) a consolidated list of device and firmware revisions currently running on the platform. The method 300 depicted in FIG. 3 may then invoke a helper module to add (operation 312) any software dependencies to the list of device and firmware dependencies. Examples of resources that may perform all or part of operation 312 include SQLite and NewtonSoft.

The method 300 illustrated in FIG. 3 connects (operation 320) to threat intelligence service 115 to analyze the current applications and their respective dependencies. Threat intelligence service 115 may, for example, check (operation 322) for any device firmware revisions associated with one or more known vulnerabilities. Threat intelligence service 115 may also check for software dependencies and any vulnerabilities associated therewith (operation 324). In at least some embodiments, threat intelligence service 115 generates and returns (operation 326) a result/recommendation that lists any firmware or software vulnerabilities and all available firmware and software updates available.

A helper module may then process (operation 330) the results/recommendations generated by threat intelligence service 115. If the helper module detects or determines (operation 332) that the platform has a good status, any remaining initialization of the platform is performed (operation 334) and normal functionality is enabled or restored. If the status is not good, the illustrated method 300 may prompt (operation 336) the user to convey that an update or other action is required for a specific device or application. The illustrated method 300 may then monitor (operation 340) for the user compliance with the update or other action identified in the prompt. If compliance is detected, the method 300 depicted in FIG. 3 connects (operation 342) an OEM update service, such as the OEM update service 117 of FIG. 1., to pull firmware updates and/or obtain any required or recommended software updates. As depicted in FIG. 3, the method 300 may restrict (operation 344) or entirely prohibit exaction of an application until compliance with the requested/recommended update is obtained and confirmed.

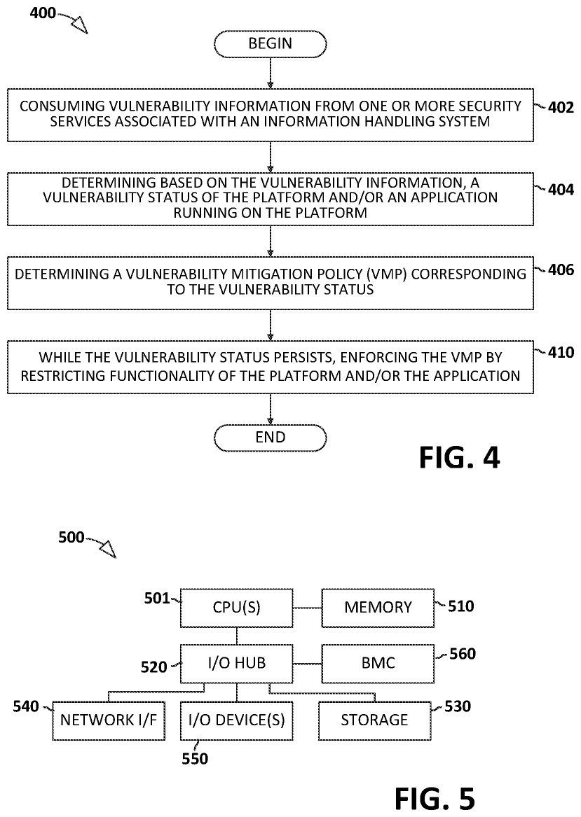

Referring now to FIG. 4, a flow diagram illustrates an accelerated vulnerability detection and automated mitigation method 400 encompassing functionality associated with the method 200 illustrated in FIG. 2 and the method 300 illustrated in FIG. 3. As depicted in FIG. 4, method 400 includes consuming (operation 402) vulnerability information from one or more security services associated with an information handling system. Based at least in part on the vulnerability information, a vulnerability status of the information handling system and/or an application running on the information handling system is determined (operation 404). The illustrated method then determines (operation 406) a vulnerability mitigation policy corresponding to the vulnerability status and enforces (operation 410) the vulnerability mitigation policy while the vulnerability status persists. In at least one embodiment, enforcing the vulnerability mitigation policy includes restricting functionality of at least one of the information handling system, restricting execution of the application, or both.

Referring now to FIG. 5, any one or more of the elements illustrated in FIG. 1 through FIG. 4 may be implemented as or within an information handling system exemplified by the information handling system 500 illustrated in FIG. 5. The illustrated information handling system includes one or more general purpose processors or central processing units (CPUs) 501 communicatively coupled to a memory resource 510 and to an input/output hub 520 to which various I/O resources and/or components are communicatively coupled. The I/O resources explicitly depicted in FIG. 5 include a network interface 540, commonly referred to as a NIC (network interface card), storage resources 530, and additional I/O devices, components, or resources 550 including as non-limiting examples, keyboards, mice, displays, printers, speakers, microphones, etc. The illustrated information handling system 500 includes a baseboard management controller (BMC) 560 providing, among other features and services, an out-of-band management resource which may be coupled to a management server (not depicted). In at least some embodiments, BMC 560 may manage information handling system 500 even when information handling system 500 is powered off or powered to a standby state. BMC 560 may include a processor, memory, an out-of-band network interface separate from and physically isolated from an in-band network interface of information handling system 500, and/or other embedded information handling resources. In certain embodiments, BMC 560 may include or may be an integral part of a remote access controller (e.g., a Dell Remote Access Controller or Integrated Dell Remote Access Controller) or a chassis management controller. Some embodiments of information handling system 500 may include an embedded controller (EC) in addition to or in lieu of BMC 560. In such embodiments, the EC may provide or support various system management functions and, in at least some implementations, keyboard controller functions. Exemplary system management function that may be supported by an EC include thermal management functions supported by pulse width modulation (PWM) interfaces suitable for controlling system fans, power monitoring functions support by an analog-to-digital (ADC) signal that can be used to monitor voltages and, in conjunction with a sense resistor, current consumption per power rail.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
consuming vulnerability information from one or more security services associated with an information handling system;
determining, based on the vulnerability information, a vulnerability status of at least one of the information handling system or an application running on the information handling system;
determining a vulnerability mitigation policy corresponding to the vulnerability status; and
enforcing the vulnerability mitigation policy while the vulnerability status persists, wherein enforcing the vulnerability mitigation policy includes restricting functionality of at least one of the information handling system or the application.

2. The method of claim 1, wherein the vulnerability information includes information indicative of vulnerability of at least one of: firmware for one or more hardware components of the information handling system, an operating system of the information handling system, a basic input/output system (BIOS) of the information handling system, and a hardware configuration of the information handling system.

3. The method of claim 1, wherein determining the vulnerability status includes determining a vulnerability score wherein the vulnerability score comprises a metric quantifying information handling system vulnerabilities.

4. The method of claim 1, wherein enforcing the vulnerability mitigation policy includes prohibiting potentially destructive operations.

5. The method of claim 4, wherein the potentially destructive operations include data wipe functions.

6. The method of claim 4, wherein the potentially destructive operations include device diagnostic operations.

7. The method of claim 1, wherein enforcing the vulnerability mitigation policy includes restricting execution of a vulnerable application program.

8. The method of claim 7, wherein restricting execution of a vulnerable application program includes prompting a user of the information handling system to update software or firmware associated with the vulnerable application program.

9. The method of claim 8, wherein restricting execution of a vulnerable application program includes preventing use of the vulnerable application program until the update is performed.

10. The method of claim 1, wherein determining vulnerability includes: enumerating devices and device firmware of the information handling system, identifying dependencies associated with the device firmware, and identifying vulnerabilities associated with the device firmware or the dependencies.

11. An information handling system, comprising:
a central processing unit (CPU); and
a non-transitory computer readable medium including processor executable instructions that, when executed by the CPU, cause the information handling system to perform operations including:
consuming vulnerability information from one or more security services associated with an information handling system;
determining, based on the vulnerability information, a vulnerability status of at least one of the information handling system or an application running on the information handling system;
determining a vulnerability mitigation policy corresponding to the vulnerability status; and
enforcing the vulnerability mitigation policy while the vulnerability status persists, wherein enforcing the vulnerability mitigation policy includes restricting functionality of at least one of the information handling system or the application.

12. The information handling system of claim 11, wherein the vulnerability information includes information indicative of vulnerability of at least one of: firmware for one or more hardware components of the information handling system, an operating system of the information handling system, a basic input/output system (BIOS) of the information handling system, and a hardware configuration of the information handling system.

13. The information handling system of claim 11, wherein determining the vulnerability status includes determining a vulnerability score wherein the vulnerability score comprises a metric quantifying information handling system vulnerabilities.

14. The information handling system of claim 11, wherein enforcing the vulnerability mitigation policy includes prohibiting potentially destructive operations.

15. The information handling system of claim 14, wherein the potentially destructive operations include data wipe functions.

16. The information handling system of claim 14, wherein the potentially destructive operations include device diagnostic operations.

17. The information handling system of claim 11, wherein enforcing the vulnerability mitigation policy includes restricting execution of a vulnerable application program.

18. The information handling system of claim 17, wherein restricting execution of a vulnerable application program includes prompting a user of the information handling system to update software or firmware associated with the vulnerable application program.

19. The information handling system of claim 18, wherein restricting execution of a vulnerable application program includes preventing use of the vulnerable application program until the update is performed.

20. The information handling system of claim 11, wherein determining vulnerability includes: enumerating devices and device firmware of the information handling system, identifying dependencies associated with the device firmware, and identifying vulnerabilities associated with the device firmware or the dependencies.
